(19) United States
(12) Patent Application Publication
(10) Pub. No.: US 2009/0097903 A1
(43) Pub. Date: Apr. 16, 2009

(54) Method and apparatus for writing while in a wet environment

(76) Inventors: Ingrid Elizabeth Hermann, Monterey, CA (US); Luiz Roberto Andrade Rocha, Monterey, CA (US)

Correspondence Address: Mona Geidl Gonzales, Suite B PMB 203, 5610 Scotts Valley Drive, Scotts Valley, CA, 95066, US

(21) Appl. No.: 11/974,352

(22) Filed: Oct. 11, 2007

(51) Int. Cl. B43K 29/00

(52) U.S. Cl. 401/195

(57) ABSTRACT

A water resistant writing device that encloses and stores a continuous roll or pad of note paper, protecting the note paper from splashed water and other moisture in a wet outside environment. The writing apparatus comprises a waterproof or water resistant compartment for enclosing and storing the note paper, a writing implement, a transparent viewing/writing window through which the note paper can be viewed while still enclosed inside the writing apparatus, a dispensing means to move the note paper through the apparatus, and a cutting means for severing a portion of the note paper.

### FIELD OF THE INVENTION

The present invention is related to writing devices and methods. More particularly the present invention is related to methods and apparatuses for writing while in wet environments.

### BACKGROUND OF THE INVENTION

A person spends an average of 5 to 10 minutes showering each day. The bathroom shower provides a quiet, warm and relaxing setting free from distractions. This environment provides a good place for a person to contemplate upcoming tasks, brainstorm ideas, and the like. Therefore, it is important that a person be able to record his or her thoughts while in the shower before those thoughts are forgotten. However, the splashing water of a shower or bath prevents one from using normal writing instruments such as a standard ink pen and paper. Splashing water will cause the paper to become too soft and waterlogged for writing, and there is a risk the ink will run on the paper causing the captured thought to be lost. Also, traditional writing instruments such as pens or pencils often will not write on wet surfaces.

A writing apparatus for use in wet environments would be greatly beneficial in other locations besides a shower or bath where moisture is prevalent. These places may include but are not limited to, health clubs, construction sites, restaurant kitchens, gardens and the like. All of these locations have some degree of moisture or splashed water. A writing apparatus for use in wet environments would ensure that persons could write without worry that their notes would become ruined by water, and also would produce a hard copy of the thought they captured.

Known writing slates configured for writing in wet environments generally mount in the shower or other places where splashed water is prevalent. A writing surface is provided that is capable of being written upon using a grease pencil or other similar water-resistant writing instrument. A wet, soapy sponge is then used to erase the writing.

However, there are a variety of problems associated with known writing slates. They do not allow the user to later remove, use or pass on the note he or she has written on the writing slate. The user must transcribe what he or she has written using traditional writing means if he or she wishes to remove the note from the shower. Known writing slates also require use of a specific writing utensil like a grease pen. Without the grease pen, the user is unable to removably write on a wet writing slate. In addition, the known writing slates also require some form of soapy wet sponge or cloth to remove writing made by the grease pen before the slate may be used again.

Known writing tablets configured for use in wet environments generally include a bound note pad of waterproof paper-like materials. Writing instruments with waterproof ink are used to write on the pages of the waterproof note pad.

However, there are a variety of problems associated with known writing tablets. Known writing tablets require the use of specific waterproof writing utensils. Without a waterproof pen, the user is unable to write on the known writing tablets when in a wet environment. In addition, prior art writing tablets which allow removal of pages from the shower may possess waterproof writing pages that cannot be written on in wet or dry environments by traditional non-waterproof writing instruments. They also do not provide a continuous roll or pad of note paper to allow one to continue writing a stream of notes without continually turning pages of note paper.

Thus, there exists a need for an improved writing apparatus that provides a means for writing in a wet environment that does not require later transcription of that writing. In addition, there exists a need for an improved writing apparatus that provides a means for writing in a wet environment that does not require the use of a special writing implement. Finally, a need exists for a writing apparatus that may utilize a continuous roll or continuous note pad of common paper or paper-like products rather than special waterproof paper, yet still provides a means for writing in a wet environment, and paper can be taken from a wet environment and written upon later using common writing implements. The combination of all these features in a single writing apparatus would advantageously enable the use of a writing apparatus without other necessary specialty items such as waterproof paper, waterproof writing instruments, or eraser sponges. This would reduce the cost and aggravation of replacing these specific writing tools when lost or entirely consumed. The combination of all these features would also greatly increase the ease of writing while in a wet environment, namely the user may write in a continuous stream without need of transcription, and may utilize any multipurpose hard edge utensil capable of applying pressure to the viewing/writing window such as a hard fingernail. The present invention satisfies these needs and provides further related advantages.

### SUMMARY OF THE INVENTION

The present invention presents a writing apparatus for use in wet environments that allows for use with multiple writing implements, allows for use without the need for transcription, and allows for use with a continuous roll or pad of common paper or paper-like products rather than special waterproof paper-like products, significantly reducing inventory costs. The present invention provides one-step functionality so that there is no need to write on a non-permanent surface only to then rewrite the note on another paper.

It is an object of the present invention to provide a method which enables the user to write in wet environments while maintaining the integrity of the paper on which the thought is captured. The user writes through a waterproof surface rather than on a waterproof paper.

Another object of the present invention is to provide a method by which a user may use a continuous roll or pad of paper secured in a waterproof case to write in wet environments and later remove the protected note paper from the writing apparatus, thereby avoiding transcription, constantly turning pages, or frequently replacing paper.

A further object of the present invention is to provide a writing apparatus for use in wet environments that utilizes common paper or paper-like products and common writing implements so that special waterproof paper and pens are not required.

These and other objects will be apparent in light of the prior art and this disclosure. In a first preferred embodiment of the Present Invention, or first version, a writing device is provided. The first version may include a casing, a viewing/writing window, a writing implement, a cutting implement, a note paper roll, and a dispensing means, where the casing comprises a waterproof material. The casing may be comprised of plastic, polymer, metal, stainless steel, rubber or other waterproof material. The writing implement may include but is not limited to a stylus, a stick, a wand or other hard material capable of being manipulated so that pressure may be applied to the transparent viewing/writing window. A user may be able to use a hard fingernail to write on the viewing/writing window as an alternative to the writing implement. The viewing/writing window may be comprised of plastic or other hard, flexible material capable of bending slightly under pressure.

The casing presents a transparent viewing/writing window feature for viewing the note paper while the note paper is still contained inside the casing. In various variations of the first invention, the note paper may be in a roll and/or optionally stacked for storage inside the casing. The casing may include a dispensing feature to allow the note paper to move from the note paper storage feature. The dispensing feature may be turned to unroll or unstack the note paper so that the note paper may be viewed through the transparent viewing window. The dispensing feature may be turned further so that the note paper travels through an opening in the casing into the outside environment. The dispensing feature may be manually operated and/or optionally battery powered.

In various variations of the first version the note paper may be a pressure paper which changes color when pressure is applied. The paper may be carbon paper, friction paper, or other pressure paper.

In various variations of the first invention the note paper may also be water and/or mildew resistant paper such as TYVEK™-like paper, nano-enhanced paper, or other paper or paper-like product known in the industry which changes color when pressure is applied.

In various variations of the first version the dispensing feature may be or comprise a crank, a lever, a knob, a battery operated switch and/or other suitable dispensing feature(s) known in the art. The dispensing feature may be configured as a knob which may be manually rotated to pull the note paper so that the note paper unrolls into the viewing/writing window chamber and then out the dispensing opening of the casing.

An alternate preferred embodiment of the Present Invention, or second version, the dispensing feature may alternately be configured as a switch that activates a battery operated motor.

In another alternate embodiment of the Present Invention, a lever is provided which may be manually pulled to move the topmost piece of a stack of note paper stored inside the writing device storage chamber. The lever may be manually pulled to move the topmost piece of note paper into the viewing window and then pulled again to move the topmost piece of note paper through the dispensing opening of the casing.

The Method of the Present Invention may further provide a method of enabling writing in a wet environment wherein a method and apparatus for writing while in a wet environment such as a bath or shower, health club, construction site, nursery or garden, or other location is provided. A subject is directed to grasp the writing implement and use it to apply pressure to the transparent viewing/writing window in a writing motion. The note paper will change color where pressure and/or alternately friction has been applied using the writing implement. A subject is then directed to grasp the dispensing feature and manually operate it so as to propel the note paper through the viewing/writing window chamber and out the dispensing opening of the casing, and thereby leaving a fresh sheet of note paper under the viewing window.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a perspective view of a first preferred embodiment of the present invention, or first version;

FIG. 2 is a perspective view of the side of first version of FIG. 1;

FIG. 3 is a cut away view of the side of the first version of FIG. 1;

FIG. 4 is a perspective view of the bottom front of first version of FIG. 1;

FIG. 5A is a detailed view of the back of first version of FIG. 1 detached from a plurality of detachable coupling devices;

FIG. 5B is a detailed view of a plurality of coupling devices attached to an external surface;

FIG. 5C is a side view of a coupling device;

FIG. 6 is a cut away view of the side of the second version of FIG. 1;

FIG. 7 is a perspective view of the bottom front of the second version of FIG. 1

FIG. 8 is a back view of an alternative version of FIG. 1;

FIG. 9 is a side view of an alternative version of FIG. 1;

FIG. 10 is a front view of a detachable coupling base;

FIG. 11 is an alternative version with a flat note paper stack and rotating cutter device;

FIG. 12 is a side view of an alternative version;

FIG. 13 is a cut away view of an alternative version;

FIG. 14 is a view of the bottom front of an alternative version;

FIG. 15 is a view of an alternative version with a handle.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

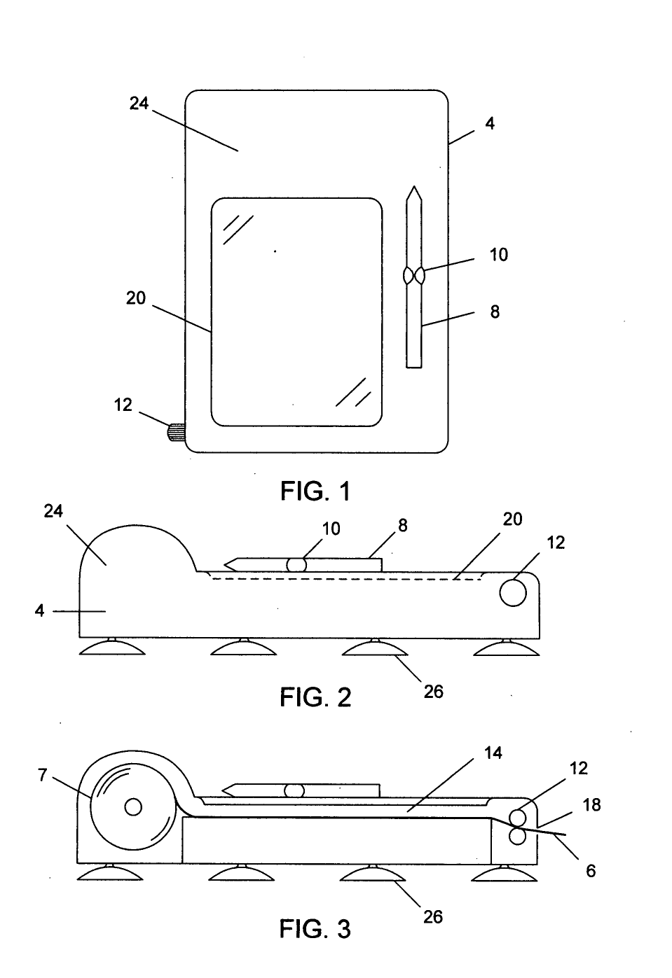

Referring now generally to the Figures, and particularly to FIG. 1, FIG. 1 shows a first preferred embodiment of the present invention 2, or first version 2, wherein a writing device casing 4 may be configured to store a roll or pad of note paper 6. The casing 4 may comprise a variety of materials, geometries, and combinations thereof. For example, the writing device casing 4 may be made from a water resistant material such as but not limited to plastic, polymer, metal, rubber or other waterproof material and may be configured to protect the note paper 6 from coming into contact with water.

The note paper 6 may be but is not limited to “pressure paper” which changes color when pressure is applied. For example, the paper 6 may be carbon paper, friction paper, or other pressure paper or paper-like product known in the industry that may be configured to change color when pressure is applied. The note paper 6 may also be water and mildew resistant paper, such as TYVEK™-like paper, nano-enhanced paper, or other paper or paper-like product known in the industry that may be configured to be water and mildew resistant paper.

The writing device casing 4 may possess a dispensing means 12. In one mode of operation of the first version 2, the dispensing means 12 may be configured to allow a subject 22 to manually turn the dispensing means 12 so that the note paper 6 unrolls and progresses through the writing device casing 4 into a viewing/writing chamber 14, past a cutting means 16, and to extrude out of a dispensing opening 18.

The viewing/writing chamber 14 may be configured so that the subject 22 may view the note paper 6 inside the writing device casing 4 through a transparent viewing/writing window 20. The viewing/writing window 20 may be configured so that the window 20 flexes enough under the pressure of the writing implement 8 so that the window 20 comes into contact with the note paper 6 underneath. The pressure thereby transferred from the writing implement 8 to the window 20 and then to the note paper 6 may cause the paper 6 to change color.

A writing implement 8 may be attached to the casing 4 by an attachment means 10. The attachment means 10 may be configured so that the writing implement 8 may be detachably coupled to the casing 4 when the writing implement 8 is not in use, and may be configured so that a subject 22 may detach the writing implement 8, grip the implement 8 and manipulate it when the subject 22 is writing on the viewing/writing window 20. The writing implement 8 is configured to transfer mechanical pressure from a subject's hand, through the transparent viewing/writing window 20 and to the pressure paper 6.

Referring generally to the Figures and particularly to FIG. 2, FIG. 2 shows a side view of the first version 2. The writing device casing 4 may possess a storage chamber 24 where the note paper 6 may be stored. The writing device casing 4 may be secured to an external surface (not shown) by an attachment means 26. The attachment means 26 may comprise, for example, but is not limited to, a plurality of suction cups.

Referring generally to the Figures and particularly to FIG. 3, FIG. 3 shows a cut away view of the first version 2. The note paper 6 may be stored inside the note paper storage chamber 24 until it may be moved through the casing 4 using a dispensing means 12. The dispensing means 12 extrudes the note paper 6 while limiting the possibility of water entering the casing 4.

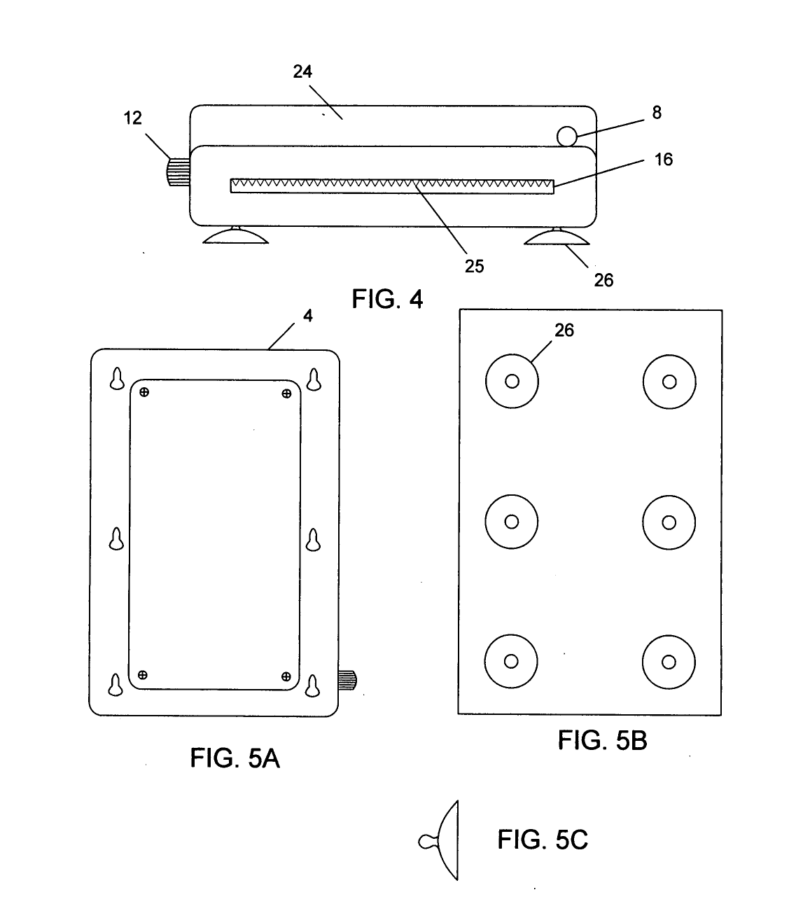

Referring now generally to the Figures and particularly to FIG. 4, FIG. 4 shows a view of the bottom front of the first version 2, wherein the writing device may include a cutting means 16. The cutting means 16 may comprise, for example, but is not limited to a serrated metal cutting edge 25, a straight sharp plastic, ceramic or metal cutting edge 23, or other cutting edge, a rotary cutting blade 21, or other cutting means known in the industry.

Referring now generally to the Figures, and particularly to FIGS. 5A, 5B and 5C, FIG. 5A shows a plurality of attachment means 26 which may be detachably coupled from the writing device casing 4. In one mode of operation, the subject 22 may attach a coupling base 30 to an external surface (not shown) by use of the attachment means 26. The subject 22 may then detachably couple the writing device casing 4 to the coupling base 30. In another mode of operation, the subject 22 may attach a plurality of attachment means 26 directly to the back of the writing device casing 4. FIG. 5B shows the plurality of attachment means 26 attached to the external surface. FIG. 5C shows a side view of an attachment means 26.

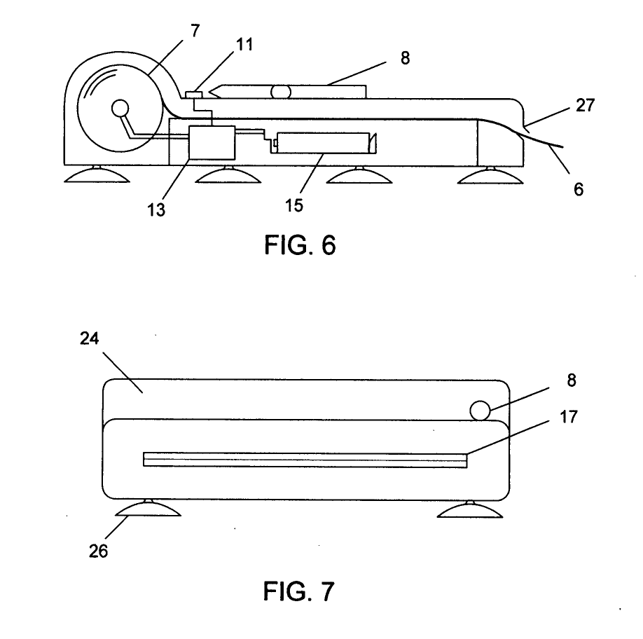

Referring now generally to the Figures, and particularly to FIG. 6, FIG. 6 shows a cut away view of the first version 2 in an alternative configuration, wherein the dispensing means 12 may be operated by a battery 15, a motor 13 and switch 11 rather than manually operated. For example, the dispensing means 12 may comprise, but is not limited to, a battery operated switch 11 which rotates and unrolls the note paper 6 when a subject 22 activates the switch 11.

Referring now generally to the Figures, and particularly to FIG. 7, FIG. 7 shows a view of the bottom front of the first version 2, wherein the cutting means 16 may be, for example, a sharp metal edge 17. The cutting means 16 may be, but is not limited to, a straight metal or plastic blade 23, a serrated edge 25, sharp overlapping plates 27, a rotary cutting blade 21, or other means for cutting the note paper 6. A safety guard 19 may be placed over the cutting means 16 to prevent the subject 22 from cutting himself.

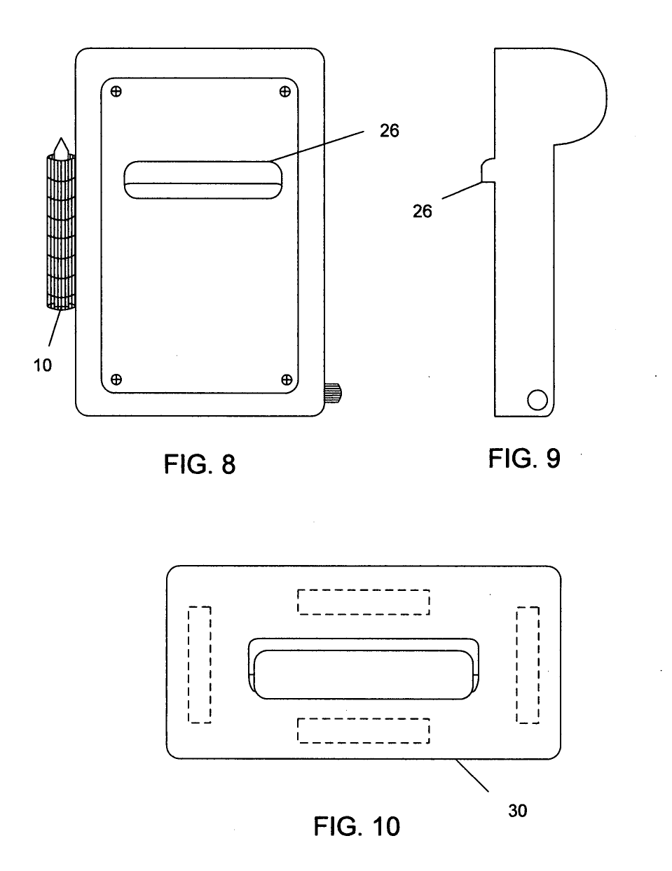

Referring now generally to the Figures, and particularly to FIG. 8, FIG. 8 shows a view of the back of an alternative version of the first version where the subject 22 may attach a coupling base 30 to a surface by use of an attachment means 26. The subject 22 may then detachably couple the writing device casing 4 to the coupling base 30.

Referring now generally to the Figures, and particularly to FIG. 9, FIG. 9 shows a side view of an alternative version of the first version where the writing device casing 4 may be detachably coupled to the coupling base 30.

Referring now generally to the Figures, and particularly to FIG. 10, FIG. 10 shows the coupling base 30 detachably coupled from the writing device casing 4. The coupling base 30 may be attached to a surface by an attachment means 26.

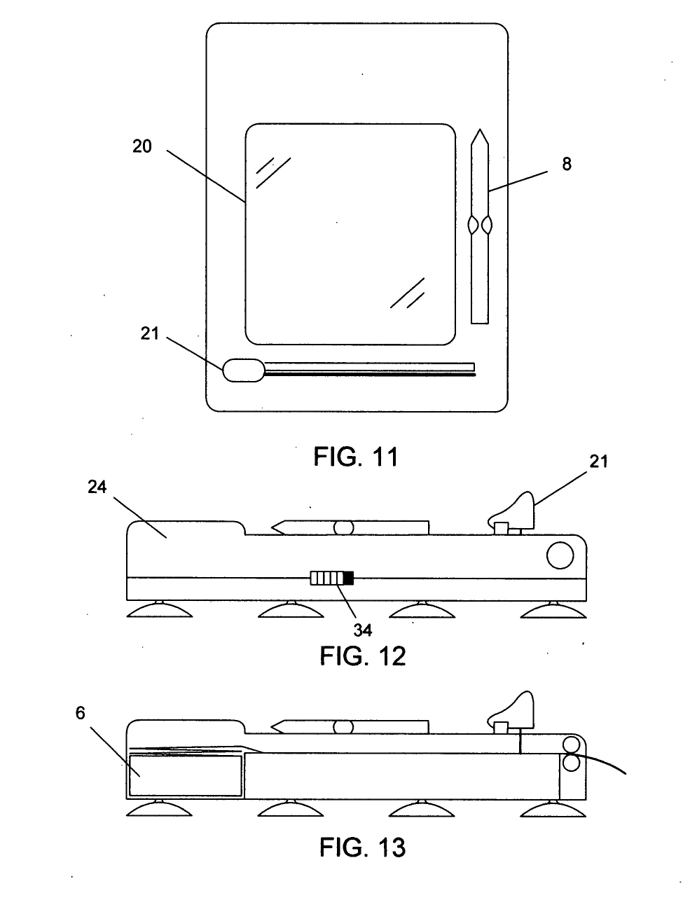

Referring now generally to FIGS. 11, 12, 13, and 14, and particularly to FIG. 11, FIG. 11 shows a front view of an alternative version of the first version 2 where the cutting means 16 may be a sliding rotating cutter 21 or other cutting means 16.

Referring now generally to the Figures, and particularly to FIG. 12, FIG. 12 shows a side view of an alternative version of the first version 2 where the back of the writing device casing 4 may be detachably coupled with the front of the writing device casing 4 by an opening means 34, thereby allowing the subject 22 to open the writing device casing 4 to replace the note paper 6, fix a paper jam, change a battery, or the like.

Referring now generally to the Figures, and particularly to FIG. 13, FIG. 13 shows a cut away side view of an alternative version of the first version 2 where the note paper 6 may be configured in a continuous accordion note pad rather than a continuous roll 7 of note paper 6. In alternate variations of the first version 2 the note paper 6 may be configured as separate sheets of note paper 6 or the note paper 6 may be perforated.

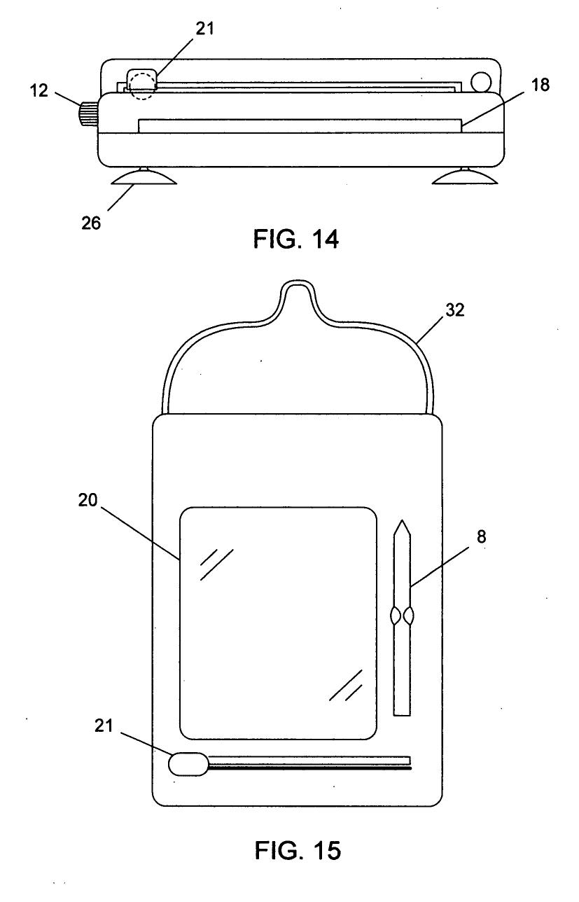

Referring now generally to the Figures, and particularly to FIG. 14, FIG. 14 shows a bottom front view of an alternative version of the first version 2 where the cutting means 16 may be a sliding rotating cutter 21.

Referring now generally to the Figures, and particularly to FIG. 15, FIG. 15 shows an alternate version of the first version 2 configured with a handle 32 so that a subject 22 may place the handle 32 over a shower head, door knob, or other item so that the writing device casing 4 hangs from that item.

Those skilled in the art will appreciate that various adaptations and modifications of the just-described preferred embodiments can be configured without departing from the scope and spirit of the invention. Other suitable fabrication, manufacturing, assembly, and test techniques and methods known in the art can be applied in numerous specific modalities by one skilled in the art and in light of the description of the present invention described herein. Therefore, it is to be understood that the invention may be practiced other than as specifically described herein. The above description is intended to be illustrative, and not restrictive. Many other embodiments will be apparent to those of skill in the art upon reviewing the above description. The scope of the invention should, therefore, be determined with reference to the knowledge of one skilled in the art and in light of the disclosures presented above.

I claim:

1. A writing device, the device comprising:
a. a water resistant casing having a transparent window, the casing configured for enclosing and storing notepaper;
b. a notepaper enclosed within the casing; and
c. the transparent window configured to enable viewing of the notepaper while the notepaper is enclosed inside the casing.

2. The device of claim 1, wherein the rear of the casing is configured to detach from the front of the casing so that the casing may be opened and the notepaper exposed, allowing access to the notepaper when the casing is opened and preventing water from reaching the notepaper when the casing is closed.

3. The device of claim 1, comprising at least one detachable coupling means configured so that the casing may be detachably coupled to an external surface.

4. The device of claim 3, wherein the rear of the casing includes at least one aperture for receiving the detachable coupling means.

5. The device of claim 1, wherein the casing is configured to receive a writing implement, the writing implement capable of being detachably coupled with the casing.

6. The device of claim 5, wherein the writing implement comprises a hard material configured for grasping by the subject during a writing movement, wherein the subject grasps the writing implement and applies pressure with the writing implement to the transparent window.

7. The device of claim 1, wherein the transparent window is operable to receive pressure delivered from a writing implement as it is propelled by the subject, wherein the pressure applied from the writing implement causes the window to contact the note paper underneath.

8. The device of claim 1, wherein the notepaper at least partially changes color where pressure is applied from the writing implement through the transparent window.

9. The device of claim 8, wherein the notepaper is pressure paper.

10. The device of claim 1, wherein the notepaper comprises a continuous roll of paper.

11. The device of claim 1, wherein the notepaper comprises separate sheets of notepaper.

12. The device of claim 1, wherein the notepaper comprises perforated sheets of notepaper.

13. The device of claim 1, wherein the device further comprises a dispensing means, the dispensing means configured for moving the notepaper within the casing and preventing the notepaper from exposure to liquid from the outside environment and enabling some notepaper to extrude from the casing.

14. The device of claim 13, wherein the dispensing means further comprises a knob attached to a first rotating bar, the notepaper interposed between the first rotating bar and a second rotating bar, wherein the knob is manually turned causing the first and second rotating bars to turn in a direction toward each other and the resulting friction between the two bars to pull the notepaper.

15. The device of claim 13, further comprising a cutting means configured to sever a portion of the extruded notepaper.

16. The device of claim 15, wherein the cutting means comprises a serrated metal edge configured so that a subject may grasp a portion of the note paper dispensed through the casing using a dispensing means and configured to sever at least a portion of the note paper from the roll when a subject pulls the note paper taut against the cutting means.

17. The device of claim 1, further comprising a dispensing opening, the dispensing opening configured to prevent water from entering the device while dispensing the notepaper from the casing.

18. A method for writing by a subject while in a wet environment, the method comprising: a. the subject grasping the writing implement; b. the subject using the writing implement to apply pressure to the transparent window; and c. the changing of color of the notepaper directly under the transparent window where pressure is applied.

19. The method of claim 18, wherein the casing is detachably coupled to a surface using a detachable coupling means.

20. The method of claim 18, wherein a cutting means is used to separate a portion of the extruded notepaper.
